(19) United States
(12) Patent Application Publication
(10) Pub. No.: US 2006/0031551 A1
(43) Pub. Date: Feb. 9, 2006

(54) System, device and method for remotely providing, accessing and using personal entertainment media

(76) Inventors: Robert Agresta, Englewood Cliffs, NJ (US); Greg Roth, Teaneck, NJ (US); David Tannenbaum, Englewood, NJ (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/128,842

(22) Filed: May 13, 2005

Related U.S. Application Data
(63) Continuation of application No. 09/946,251, filed on Sep. 5, 2001, now abandoned.
(60) Provisional application No. 60/230,511, filed on Sep. 6, 2000.

(51) Int. Cl. G06F 15/16

(52) U.S. Cl. 709/231

(57) ABSTRACT

Systems and methods for permitting consumers to securely purchase, access, download and/or stream entertainment content such as musical and audio visual works, including a remote terminal or terminals. Consumers subscribe to the system and obtain a terminal or terminals. The terminals permit the subscribers to access the system to obtain content, either by downloading same to the terminal or by directly perceiving the content while streaming the content to the terminal. The invention prevents unauthorized copying, distribution and/or performance of protected works while at the same time eliminating the need for consumers to possess the tangible objects, e.g. CDS and DVDs, upon which detectable works normally reside. The software associated with the system regulates the transmission of content from the database(s) upon which it is stored, through a central server associated with the system, to the subscriber terminals for storage or immediate, i.e., “streaming”, playback.

### CROSS REFERENCE TO RELATED APPLICATIONS

This application is a continuation of U.S. patent application Ser. No. 09/946,251, filed Sep. 5, 2001, which claims priority to U.S. Provisional Application Ser. No. 60/230,511, filed Sep. 9, 2000. These applications are hereby incorporated by reference in their entirety.

### BACKGROUND OF THE INVENTION

1. Field of the Invention

The present invention relates generally to a system and method for purchasing, storing, streaming and/or playing personal entertainment media, such as music and/or audiovisual works, and, more particularly, to a system which permits consumers to create, access and/or modify custom playlist(s) composed of content selections from the consumer's collection of musical and/or audiovisual works, and to access all or portions of the playlist(s) on demand.

2. Description of the Related Art

Since the invention of piano rolls in the late nineteenth century, music and the medium that carried it have been bound together. As Edison's original wax cylinders gave way to vinyl platters, audio tapes, and compact discs (“CDS”), both record companies and consumers have come naturally to think as part and parcel of a tangible thing to be bought and sold. Today, the sale of a tangible article containing music—the album or CD—is a familiar transaction, supported by well developed marketing, distribution and accounting systems. Not surprisingly, the album and CD have become a familiar way for artists to package their music. And, similarly, consumers believe that owning the tangible object that contains the music is synonymous with “owning” the music embodied in the tangible article itself, with all that that implies, including the right to play it as often, and whenever and wherever, he or she wants, as well as the right to give or loan it, and to copy it.

Now, digital technology is revolutionizing the music business by severing the bonds between the music and the tangible object that carries. The advent of the internet and such thing as “CD burners”, consumers have begun to “swap” music files under the guides of “file sharing” that which is their own property. In 1999, the file sharing utility which ultimately became known as “Napster” was introduced. Napster presented a new and extremely popular way for people to reproduce copies of musical works by making it possible to find and listen, and in fact make a copy of, any song from any era, almost instantly. This resulted in the acquisition of 250,000 new users per week on the Napster website and a total user base of over 20,000,000 users. However, the owners of copyrighted music catalogs rightfully objected to the unauthorized reproduction of the protected works, and eventually, through judicial intervention, put Napster off-line. This action, and action against similar outfits, has left a gap of 20,000,000 people in the on-line music market in search of content.

The selection of available musical and audiovisual entertainment media available to consumers today is vast. Consumers routinely collect a wide array of entertainment media, such as on compact discs (“CDS”), digital audio tapes (“DATs”), VHS tapes and digital video discs (“DVDs”). These types of media consume space, and thus it is extremely inconvenient to transport one's portfolio, or any meaningful segment thereof, for remote usage. Additionally, consumers often are only interested in owning or playing a portion of a given work, such as some but not all of the tracks on a CD. The current state of the prior art does not provide adequate solutions to these needs.

One innovative, although incomplete, solution to this problem is “digital cable radio,” by means of which subscribers can listen to one of any number of different “musical channels” (each of which carry a different music or other audio format) transmitted over the public cable television network to a cable decoder apparatus. Unfortunately this format severely constrains available selections to those chosen by the content provider. Thus the format falls short in that it cannot be custom tailored by the listener, for the listener.

U.S. Pat. No. 5,819,160 to Foladare, et al. attempts to address the problem that, at present, to access content, one must posses a tangible article (e.g. CD or DAT) in order to listen to a selection of music or access other entertainment content. Foladare permits consumers to subscribe to a service which will assemble a variety of playlists in the subscriber's account and permit playback of those playlists on demand by the subscriber. However, Foladare does not contemplate the creation of a database in the form of an accumulation of single selections which can be accessed individually or in groups on demand by the subscriber. This greatly limits the versatility and usability of the system of Foladare.

There is currently no standard way to purchase music, whether on-line or not.

In light of the aforementioned, a system (and method for its implementation and use) is needed, through which consumers can purchase content (e.g. music, audiovisual works and/or any other entertainment or information media) either individually, or in groups, for immediate access. The purchase may be conducted through automated processes (which may or may not be accessed by wireless means) without the constraint of purchasing the content in predetermined collections (e.g. a complete musical album consisting of multiple tracks), although such predetermined collections may also be offered.

### BRIEF SUMMARY OF THE INVENTION

Based on the foregoing, it is a primary object of the instant invention to provide an entertainment media device and/or software, system and method that provides a central database of available entertainment content (e.g. music) which may be purchased, organized and accessed from a subscriber's device.

It is also an object of the instant invention to provide an entertainment media device, system and method that provides a central database of entertainment media that may be remotely and uniquely created, accessed and played from a stand-alone device.

It is another object of the instant invention to provide a device, software and/or system that allows users to personally select, access and play entertainment content, such as music or video, from a remote location without having to physically handle the medium storing the [media] content.

It is an additional object of the instant invention to provide a device and/or system that accesses entertainment media and plays it from a remote device.

It is a further object of the instant invention to provide a device, software and/or system that allows a user to create a plurality of playlists of selections of entertainment content from the user's collection of purchased content.

It is a further object of the instant invention to provide a device, software and/or system that allows for the purchase of a single copy of a musical, audio visual or other copyright protected work where the user does not need to obtain a tangible object in which the work is embodied, but where the copyright owner can fully monitor and control the use(s) to which the work is put.

In light of these and other objects, the instant invention comprises, in one embodiment, a device, hardware, software and/or system and the means necessary to connect the hardware and/or software to a communications network, for securely purchasing, accessing, streaming, obtaining, playing and/or storing entertainment content such as musical and audiovisual works for non-commercial or commercial use. The system enables a user to remotely purchase, store and access all or portion of a personally generated entertainment collection from anywhere and at any time. By using this system, consumers will be freed from problems associated with physical media, including loss or damage to said media and the inconvenience of physically transporting such media. The invention replaces the physical media, such as CDS and cassettes, with a device and/or system that securely accesses entertainment content (e.g. music or other work such as audiovisual works) stored in a remote database. The invention makes entertainment media universally available for purchase, storage and access so that a user can select, receive, stream and play entertainment selections, such as audio or video, from a remote location. The invention allows a user to accumulate and create an entertainment or music collection list that is digitally accessible from anywhere and at anytime. Although the instant invention is tailored for storing, selecting, accessing and playing musical media, it may be employed for other types of data, such as video, news, sports, etc. The invention includes a remote playing device having software and a telecommunication transceiver that allows it to communicate with a central database over, for example, a global communication network, to access and receive media content. The media content may comprise a predetermined set of media and/or a personally chosen selection of media.

The instant invention allows consumers to instantly buy and/or license the rights to any musical/audiovisual or other entertainment media on demand while permitting full control of the intellectual property rights of the underlying content by the owner. The system will be implemented through the use of interactive terminals. Among the types of terminals which may be used with the system are wireless, portable terminals (such as a device similar to a “Walkman®”), terminals using Moving Picture Exports Group I, Audio Layer 3 (“MP3”) formatted devices, a home stereo-type terminal, and/or a car stereo-type terminal. Terminals such as the “Walkman” and/or “MP3” variety are preferably relatively small, hand-held, devices that will run primarily from an internal power source, such as batteries. It should be noted that the playing device does not necessarily have to be hand-held and may comprise a relatively stationary playing device, such as a home or car stereo. The home stereo-type terminal would preferably, but not necessarily, access the central database through a land-line computer modem or cable modem that may access a global communication network in order to access the system. A remote hand-held device preferably uses a wireless system, such as a packet switching network (PSN) or any packet, cell or similar network in which data is transmitted in discrete quanta and/or a global communication network, to access the central system content using the subscriber's ID number. Optionally, the invention may employ Cellular Digital Packet Data (CDPD) technology or other known or to-be-created wireless publicly accessible communication technologies. However, the invention preferably employs PSNs because of their compatibility with the Internet. The car stereo-type terminal may take any suitable form, but obviously must be capable of receiving and transmitting radio or microwave frequency or digital signals as a wireless mobile unit or have another method of communicating with a host server.

The instant invention includes the means necessary for opening consumer accounts. A consumer can become a subscriber to the system by opening up an account in the system. Once this is done, the subscriber can order a terminal or terminals for use with the system and can begin ordering selections of his or her choice from a database of selections available in the system. Once a user subscribes to the system, the subscriber is assigned an identification number or password and, if desired, a personal identification number (“PIN”), and a terminal that preferably has its own unique identifier. The terminal identifier will electronically identify and match the user and the terminal. In this way, the theft of a terminal, or the theft of an identification number, singularly, will still not permit the thief from obtaining access to the subscriber's account.

Once a subscriber purchases a selection of entertainment media, the subscriber will have instantaneous access to it. The subscriber accesses his or her selections through a global access network using landline modems or wireless communication technology. A user first accesses the central database to purchase new content and/or access previously purchased content. Upon accessing the central database, the user selects a single selection of content or a preconfigured playlist or generates a new list which is stored in a specific memory location within the central server or a user's computer or playing device that is accessible only by an authorized accessing party such as the subscriber associated with that particular terminal. Prior to transmission of the selected playlist, the selection is digitally compressed, and, if desired copy protected and encrypted, using methods known to the art. The selections purchased by any given subscriber are known as the subscriber's roster or playlist. The subscriber's roster is updated each time the subscriber purchases a selection, either automatically by the system or the terminal or manually by the subscriber. The roster is stored in the subscriber's terminal and central server and only needs to be updated when new selections are added.

Copyright protection technology such as EMMS Digitals Right Management Technology developed by IBM, Content Protection for Recordable Media developed by the consortium comprised of Intel, IBM, Matshusita and Toshiba and/or the Secure Digital Music Initiative (“SDMI”), or comparable copy protection, will be ideally suited for use with this invention.

The system of this invention provides for a virtually infinite storage capacity since all content is stored on the host server, which can be scaled up in size in response to demand.

When the subscriber makes a selection, the terminal preferably uses a high speed Internet or other telecommunications connection to access the appropriate location of the selection. The user will have the option of “streaming” the selection to the terminal for instant access and simultaneous playing, or downloading the selection onto the memory of the terminal. Downloaded selections are stored in one of several quick memory locations and allow for access to entertainment content when the subscriber is in a non-network service area. When the user is within a location that allows simultaneous access and playing of selections, the selected media does not need to be stored in the memory of the playing device. Selected media may also be downloaded and stored on the playing device for subsequent play outside the immediate communication zone. The number of quick memory locations on any given terminal may be limited, so as additional selections are downloaded the user can choose which selections to over-write to keep their hand-held selections current. In one embodiment, each terminal will have the ability to be linked to other terminals, which will allow a subscriber to play and/or transfer his or her selection(s) to or through any other subscriber's system. Once linked terminals are disconnected, the second subscriber's system will no longer have access to the first subscriber's roster. If content is transferred to the second subscriber's device the system of this invention will automatically cause the purchase of rights to the content by way of the purchasing feature of the instant invention.

Various technologies currently exist which are suitable for use with the system. Wireless digital system communications, audio compression algorithms and formats, secure connection schemes, and audio platforms are all known to the art and may all suitably serve as the basis for implementing the system.

The system may be configured such that each subscriber may only need to purchase one terminal, which is used to access system and download content therefrom, and which will also connect to remote devices such as a car stereo or home stereo by suitable communication link such as cables or wireless transmission of data.

It is also important to note that, since an entire collection of content, such as music be copyright to which is owned by the various record companies, will, ideally, reside in a database within or connected to the central server, the instant invention presents a single virtual cite at which consumers can purchase copies of available content without ever having to take possession of unnecessary tangible items such as cd's or cassettes which can be accessed from virtually any location on earth given suitable communications availability or if such content has been downloaded to the subscriber's terminal.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a diagrammatic representation view of the overall system of the preferred embodiment of the remote media access system of the instant invention.

FIG. 2 is a block diagram of the overall system of the preferred embodiment, playing device and central database system of the preferred embodiment of the remote media access system of the instant invention.

FIG. 3 is a system diagram of the overall system of the preferred embodiment, playing device and central database system of the preferred embodiment of the remote media access system of the instant invention.

FIGS. 4A-B are flow diagrams of the software operation of the remote media access system of the preferred embodiment of the instant invention.

FIGS. 5A-H are diagrammatic representations of suitable database configurations in accordance with the preferred embodiment of the instant invention.

FIG. 6 is a diagrammatic representation of a system of the instant invention which does not employ the Internet.

FIG. 7 is diagrammatic representation of a system of the instant invention which does employ the Internet.

### DETAILED DESCRIPTION OF THE INVENTION

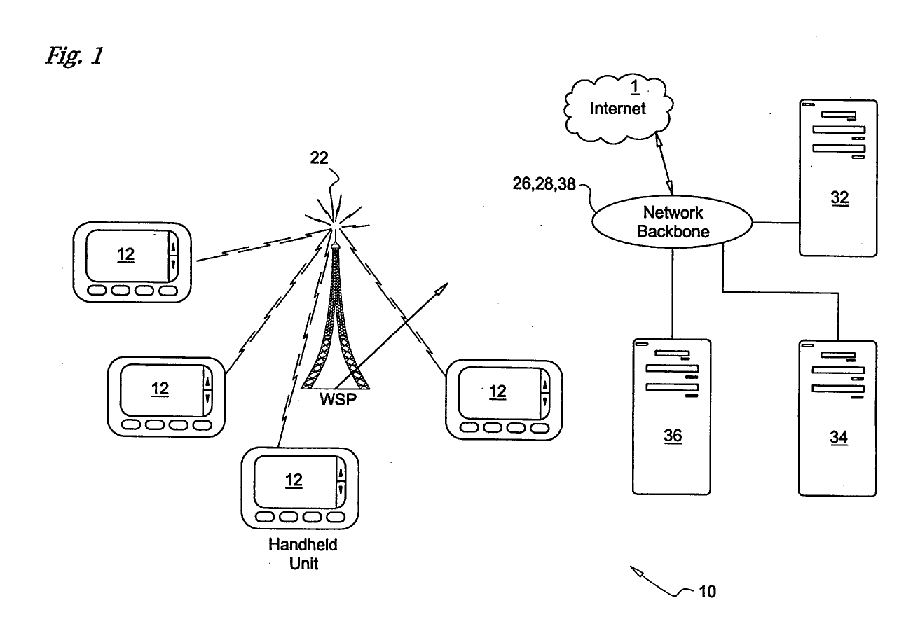

With reference to the drawings, FIGS. 1-5A-H depict the preferred embodiment of the instant invention, which comprises a device, system and method for remotely accessing media content, such as audio and/or video media, and is generally characterized as a remote access media controller designated by reference character 10. The invention 10 preferably comprises a device and/or system of hardware and/or software and the technological means to connect the hardware and/or software to a communication network. The system relates to a network of playing devices 12 which access and retrieve multimedia content like music or video via a wireless or landline broadband connection into said devices 12. The playing devices 12 include hardware and software that retrieves, processes and decodes the content in the form of digital data into audible and/or viewable analog signals, which are then played and made perceptible to humans through at least one speaker and/or display. The playing devices 12 may comprise a portable hand-held unit 12, a car stereo, a home stereo, portable stereo, video terminal or other audio and/or video playing device. The playing device may comprise a processor based unit that connects to and communicates through a globally accessible network through a modem, cable modem, DSL, T1, T3 or through a wireless connection, such as a packet switched network (PSN), or cellular digital packet data (CDPD) system and link. The instant invention 10 takes advantage of known communication devices and systems in a unique manner that allows a user to remotely access, purchase and create a personal music and/or audio or video play list from a central database and play the selected play list upon demand.

The “central” database of entertainment content may be a single memory device or a plurality of interconnected memory devices in a single location, or a plurality of memory devices in remote locations. For example, the owners of copyright to the various works that may be made available on the system may wish have such works physically reside on their own databases which they can control. In such a case, those remote memory devices will be connected to the central server such that individual works can be retrieved electronically therefrom through the central server and transmitted to subscriber terminals.

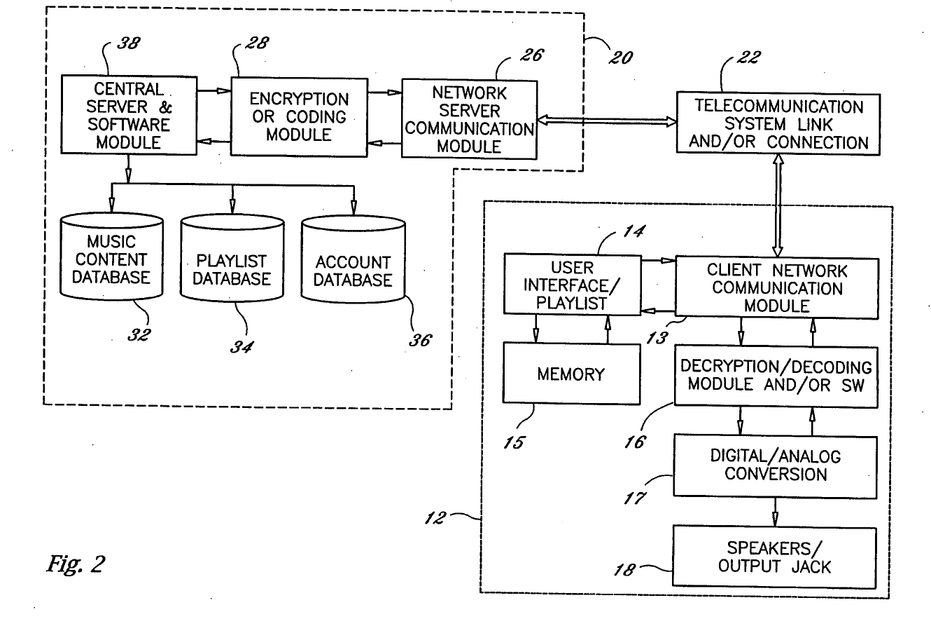

With reference to the drawing figures, the remote access media controller 10 preferably comprises a device, system and method for selecting, purchasing, authorizing, remotely accessing, streaming and/or playing a collection of audio and/or video content found on a central database or databases represented by element 32 in FIG. 2. The system includes at least one playing device or subscriber terminal 12 adapted to communicate with server 20 through network interface card 24 and receive and play audio and/or video data content, a central database and server system 20 for controlling requests, transmissions and content, which includes at least one content server 38, and software 100 that facilitates the collection and tracking of media recordings, creation of personal playlists, the transmission of digital audio/video data or requests to and from the central station 20 and playing device 12 and other entertainment information such as song/video names, artist, genre, length of recordings and recording progress tracking. The features of the software 100 may reside at the central server 20 and/or may have at least a portion of the software or complementary software residing in the end-user playing device 12. The remote access media controller 10 is preferably adapted for Internet communication and data exchange over landline modems or wireless transmission systems to accommodate the Internet consumer in selecting, purchasing, receiving and playing audio and/or video productions. The remote access media controller 10 may be adapted for use in other public communication networks, but is preferably adapted for the Internet because of the Internet's prevalence and popularity. The remote access media controller 10 may be accessed and used through computer modems, cable-modems, T1-T3 connections, PSN, CDPD, TCP/IP, other known landline or wireless communication networks and/or other known or yet-to-be-developed communication systems. It should be noted that communication in the form of PSN or any packet, cell or similar network in which streaming data is transmitted in discrete quanta is preferred over CDPD, as CDPD overlay is less preferred at present for the uses of this invention due to bandwidth availability and flexibility of CDPD.

The terminal 12 will preferably have a human/machine interface which will permit subscribers or other users of the particular terminal 12 to communicate with the central server 20. The interface may be in the form of a keypad, a voice recognition interface, or other interface devices (not shown) which will permit the user of the terminal to communicate with the central server 20. Such communication will entail writing commands to the central server for content to be retrieved and transmitted to the terminal for playback, and also to permit a user of the terminal to create and configure playlists, modify playlists, and/or program preferences into the software within the central server which will cause the central server to automatically create playlists and/or purchase new content as it becomes available based upon discrimination criteria provided by the subscriber. Terminal 12 will also preferably have a screen which can depict textual or graphical messages or from which textual or graphical entertainment media content can be perceived, at least one playback speaker, and at least one ear phone jack to permit a user of the terminal to enjoy content transmitted from the server. In addition, terminal 12 may or may not employ a video monitor as well as one or more ports or plugs (not shown) which will permit the terminal 12 to be connected to another device such a home or car stereo with suitable corresponding plug/receptacles.

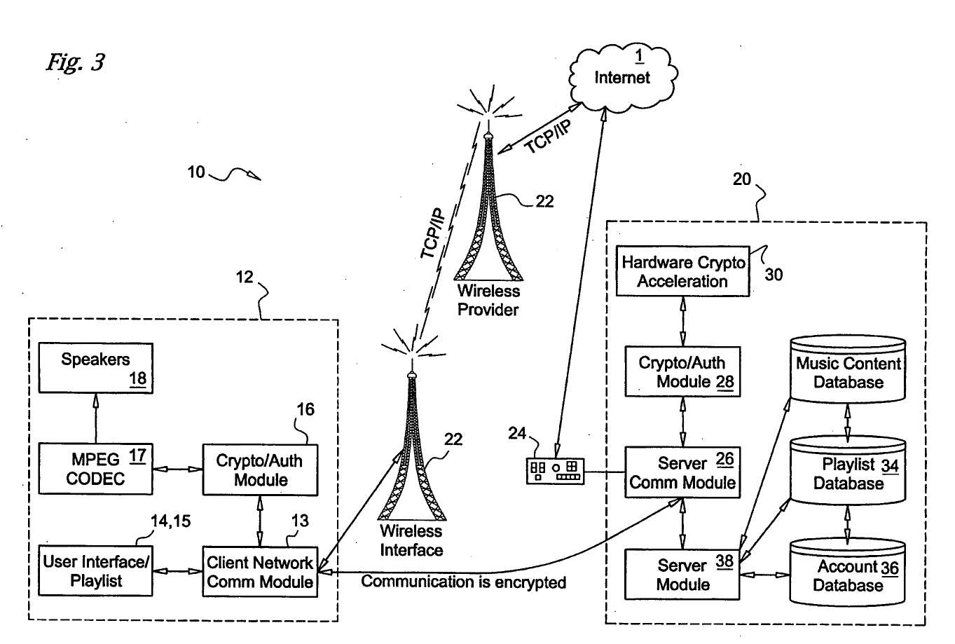

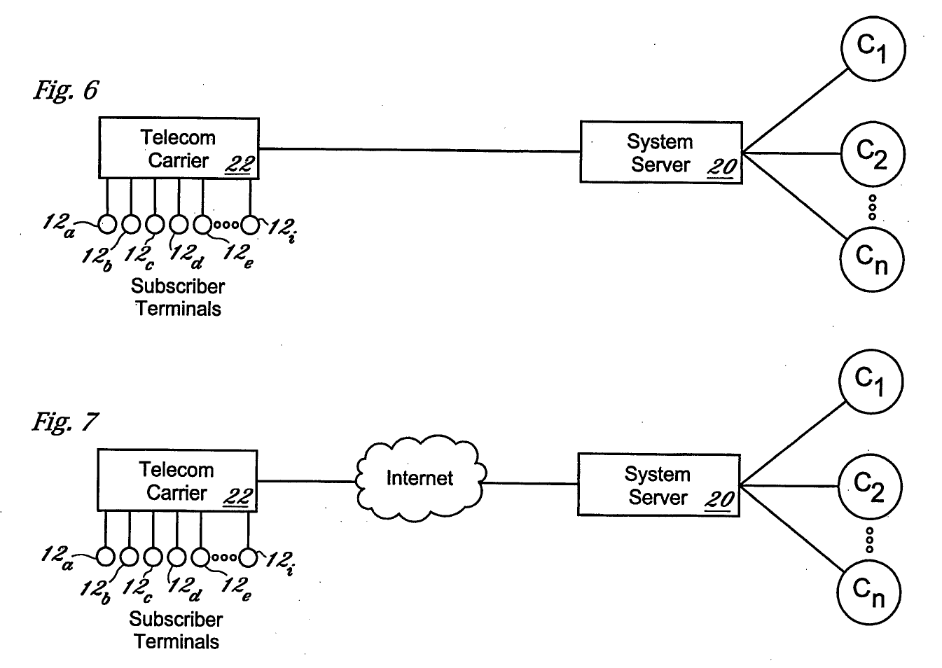

With reference to FIGS. 2 and 3, the instant invention 10 gives authorized users/purchasers (e.g. subscribers) access to and allows them to create, configure and modify playlists and download and play entertainment selections stored on or accessible by a central content server 38 from terminal 12, such as hand held units, car stereos, portable stereos and home stereos, without touching or changing a hard copy of the material objects on which those selections reside, such as CDS and DVDs. The instant invention 10 downloads music from a central database system 20 using a public access network or communication system, such as a land line or wireless modem, a standard computer modem, cable modem, DSL, packet switching network (PSN), wireless cellular and/or digital communication system (CDPD) or other communication and data transfer techniques. The central database system 20 comprises a central server 38, an encryption/coding module 28, a database or databases comprising a music content database 32, playlist database 34 and account database 36, and a network server communication module 26. The central server runs software 100, processes orders and commands and controls the flow and transmission of data from the databases 31-40 and the end-user playing device 12. It should be noted that a series of databases may be employed to make up the music content database 32, such as where the various catalogues of content are held by respective owners thereof, such as the various “record companies.” FIG. 6 depicts a system wherein subscriber terminals 12 communicate with the system server 20 by a telecommunications link such as telecom carrier 22, and the system server 20 in turn accesses and can retrieve upon demand copies of works held in databases C₁, C₂ . . . Cₙ which represent databases/catalogues of entertainment or other content residing on the proprietors' proprietary systems. FIG. 7 depicts a system similar to that depicted in FIG. 6 but where the telecommunications link between the subscriber terminals 12 and the system server 20 includes an internet component.

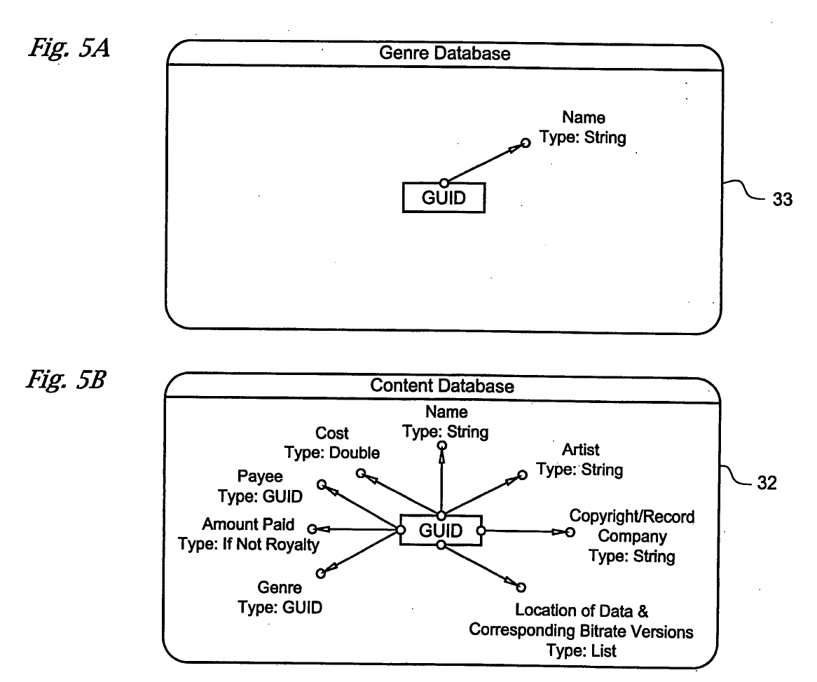

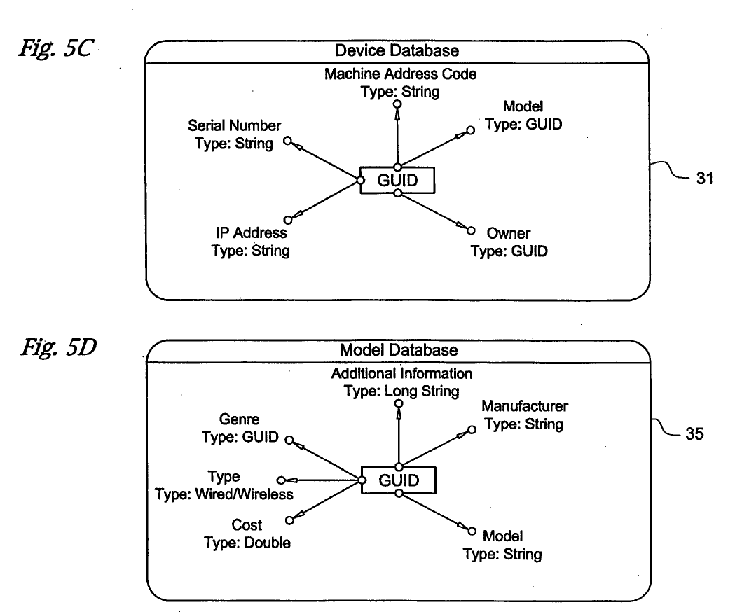

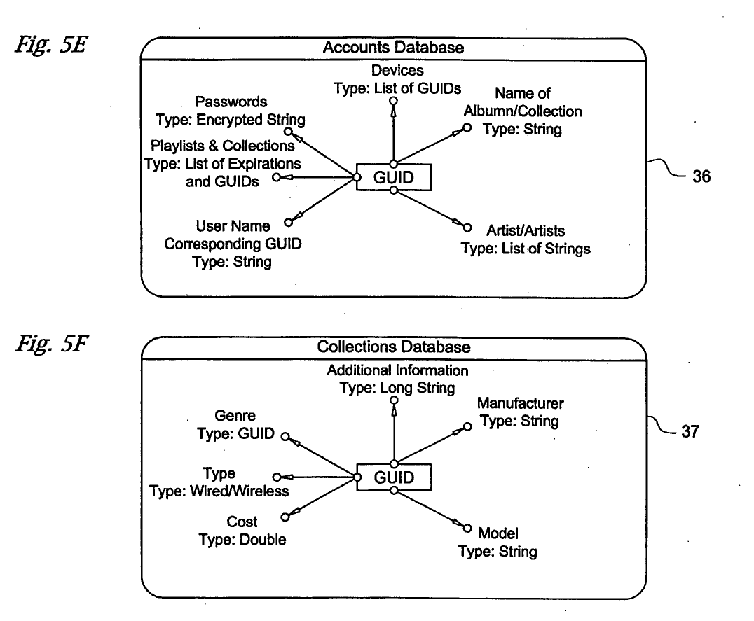

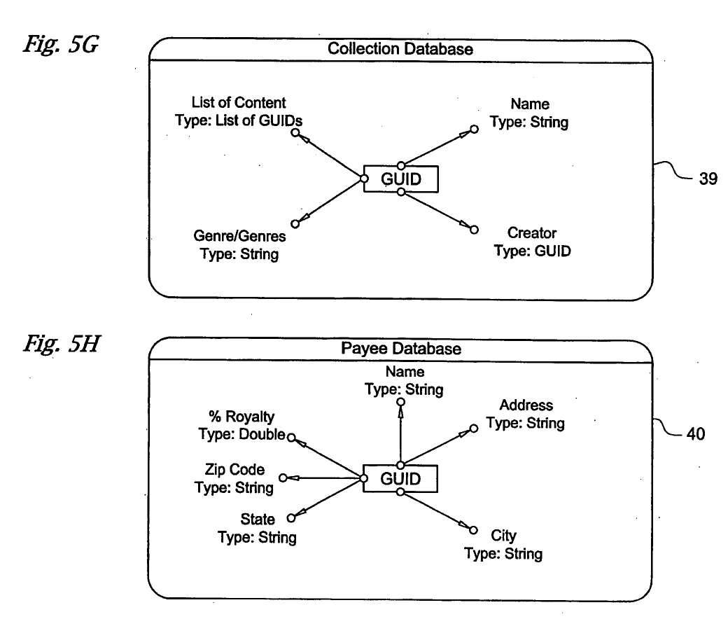

Referring to FIGS. 5A-5H, a global unique identifier database (GUID) pointer may be used to simplify, accelerate and organize the database search process. The GUID is a type of tag and/or pointer that the computer or processor based system or device of the invention uses to look up, identify and retrieve data from a particular database, such as customer names, song names, song genre and playlist. The instant invention can employ any number of databases to store and retrieve any information or data related to such topics as the content, subscriber, accounts, collections and the end-user devices, as shown in FIGS. 2, 3 and 5A-5H. With reference to FIG. 5A, the central server system 20 may include a genre database 33. A music content database 32 can store music selections available for purchase or licensing and related information, such as song names, artists, record company, copyright owner, location of data and corresponding bitrate versions, genre, amount paid, payee and costs, as shown in FIG. 5B. With reference to FIG. 5E, the account database 36 may include a devices list, content, subscriber account information, user names and corresponding GUIDS, playlists and collections and passwords. With reference to FIG. 5C, an end-user device database 31 may comprise end-user device 12 related information, such as an address code, serial number, IP address, owner and model, and a model database 35 shown in FIG. 5D comprises additional device related information, such as manufacturer, cost, whether the device is a wired or wireless device and genre. A playlist database 34 may be used to store and provide available predetermined playlists or customized playlists. A collections database 37 may be employed for track lists, name of album/collection(s), artist(s), costs, recording company, copyright owner and genre, as shown in FIG. 5F. Referring to FIG. 5H, a user collections database 39 may be employed for song names, creators, genres and lists of content, and a payee database may be used for names, addresses, and amount owed or terms for payment. As best seen in FIG. 2, encryption/coding module 28 comprises a public/private key encryption methodology/technology to encrypt requested data prior to transmission to prevent unauthorized access, copying and use of the data. The network server communication module 26 establishes a broadband telecommunication link 22, either through a land-line/wired link (such as a modem, cable modem, DSL or T1-T3) or a wireless link (such as PSN or CDPD), over a designated global access network, such as the public telephone system or the Internet, and an end-user playing device 12 for receiving customer requests and transmitting purchased audio and/or video media data from the corresponding database(s) 31-40 to the end-user playing device 12.

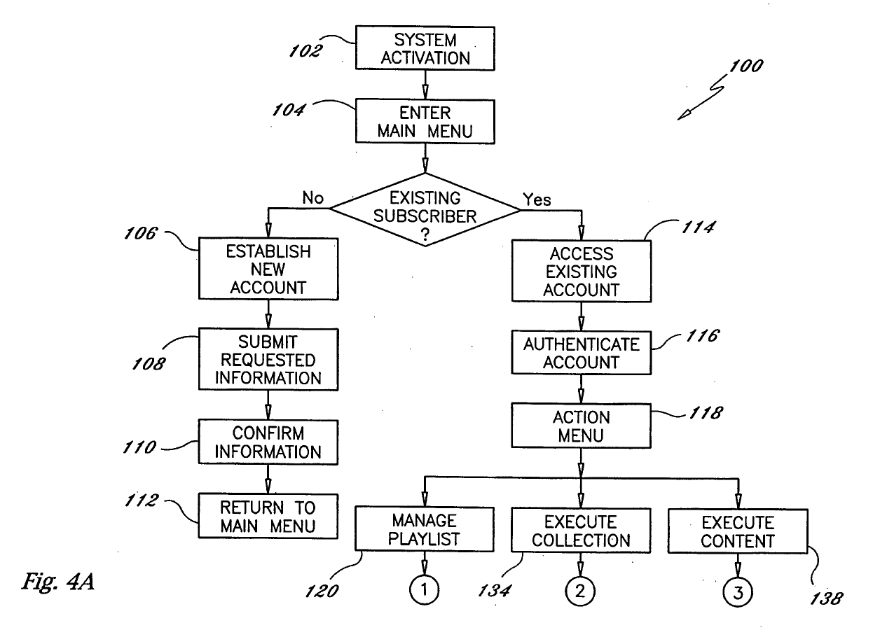

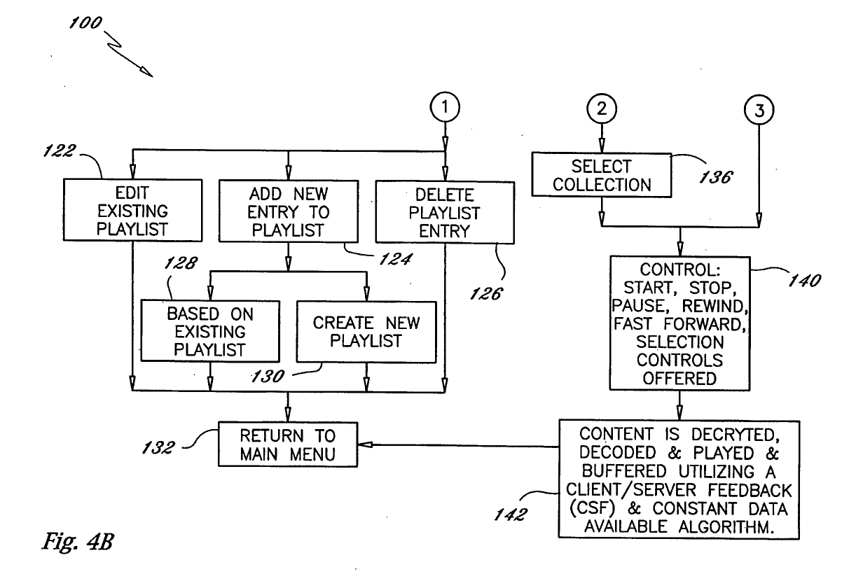

Referring again to FIGS. 2 and 3, the end-user playing device 12 comprises a client network communication module 13, user interface playlist 14, memory 15, decryption/decoding module and/or software (SW) 16, digital-to-analog conversion module 17 and at least one output device such as speaker 18 or outputjack (not shown). The client network communication module 13 establishes and controls the telecommunication link 22 with the central database server system 20, transmits user requests and receives media content data responsive to the request. The requested media content can then be loaded into a new playlist or an existing playlist 14 and/or stored in memory 15. The decryption/decoding module 16 decodes received media content so as to make it available for play. The D/A converter 17 converts media content from its digital form to analog for playing through the output device(s) 18. The central database server system 20 communicates with the end-user playing device 12 through the telecommunication link 22 and in cooperation with the software 100 provides entertainment media content for purchase, receives and processes end-user requests, uploads requested content from the database 32 or 34, and transfers it to the end user playing device 12 where it is automatically uploaded, stored and available for play. In fact, in a land-line telecommunication link or a broadband wireless PSN link or comparable link the purchased media can be simultaneously uploaded, stored and played. A flow control engine of the software 100 facilitates the simultaneous access and play of content by employing and monitoring the level of data in a designated buffer and pausing and resuming transmissions based on the monitored level, as more fully described below. In another embodiment, the instant invention 10 has the ability to take content that was transferred into a home, portable or car stereo playing device 12 and transmit it to a wireless portable device 12 for simultaneous play with the portable playing device 12 when it is within a predetermined range from the stereo device. Once the playing device 12 is outside the acceptable range it only plays the content stored in its memory 15. Regardless of the particular embodiment employed, the instant invention preferably incorporates software 100, similar to that shown in FIGS. 4A and 4B, to achieve the objects of the instant invention 10 and allow a user to create or access a personal playlist or collection that may be played, stored, edited and/or deleted at the whim of the user.

The wireless version of the playing device 12 can be either a mobile unit such as a Portable Audio Unit (PAU), an Automotive Audio Unit (AAU), or a Stereo Component Unit (SCU). Each device 12, whether wireless or wired, possesses similar capabilities in that it can access a plurality of databases 31-40 with a large collection of music/video/data and download content such as specific tracks, sets of tracks, or albums to be played and heard directly from playing device 12, either simultaneously or subsequently. The playing device 12 preferably includes a speaker 18 or a headphone j ack or j acks. Entertainment media content played from a wireless device 12 is preferably transferred and communicated to and from the central server station 20 using PSN or comparable link so as to be compatible with the Internet. PSN partitions a recording into packets or frames which can then be transmitted using a streaming audio protocol (SAP). This allows music or other media to be downloading and playing at the same time. It can also be downloaded ahead of time into the playing device's memory to be stored for future playback. The software 100 of the invention cooperates with the central system 20 and playing device 12 to access, select, acquire, retrieve and play desired media content.

With reference to FIGS. 4A and 4B, the software 100 of the instant invention allows new subscribers, who must first register at steps 106-112, and/or existing subscribers, to access an action menu at steps 114-118 for the purpose of editing, creating or deleting a playlist at steps 120-126, to execute a collection at steps 134-142 or execute content at steps 138-142. Prior to or after transmission, depending on where the relevant software resides, the selection is decoded, decrypted, buffered and played utilizing client/server feedback and/or data algorithms. In order to effectively process, save, transmit and play recorded media content, the software 100 comprises several subroutines, referred to herein as engines, which communicate, transfer, monitor, update and control the recorded media. The engines include a user engine, a transfer engine, a rendering engine, a flow control engine and a user interface engine.

The Transfer Engine

The transfer engine takes packets of streamed content data from the central server and transfers it into a main playback buffer, which is set up as a FIFO (first-in-first-out) buffer. The transfer engine is the primary server control segment responsible for communicating requests for user specified data, content or collections to the server 38 and transferring the data received directly into the playback buffer for transmission to the playing device 12. The transfer engine serializes requests for content and manages data requests from the server. The transfer engine communicates desired content and awaits its arrival. That is, the transfer engine communicates requests for content to the server in a way that the server is prepared to send requested content upon completing the transfer of previous content streams.

The Rendering Engine

The rendering engine takes data from the playback buffer and prepares it for playback. The rendering engine routes data through an amplifier and then an A/D converter for playback. The rendering engine retrieves and removes data from the beginning of the data buffer so that the data may be decoded and processed for conversion from digital to analog audio signals and amplification such that the audio signal is made audible. The rendering engine retrieves and removes data from the beginning of said playback buffer and is responsible for inducing the transpiration of all processing/decoding/decrypting/demodulating of the data so that the data can be decoded and converted to analog audio signals and amplified for audible playback. The rendering engine notifies the user interface update engine of progress and receives requests for the buffer flushing and start/stop/pause resume playback commands from the user interface update engine.

The Flow Control Engine

The flow control engine has the sole responsibility of managing the utilization of the playback buffer. That is, flow and buffer levels are managed by the flow control engine. The flow control engine monitors the quantity of data in the playback buffer and sends pause commands to the server 38 when the buffer is full or near full, that is when the playback buffer containing data reaches the maximum bytes threshold. The flow control engine also monitors the quantity of data in the playback buffer to determine when it falls below the low threshold and when it does it sends a command to the server to resume downloading. The low-end and high-end thresholds are preferably set to maximize efficiency. Buffer capacity varies based on memory and bandwidth. The lower the bandwidth the larger the buffer needs to be, and, conversely, the larger the bandwidth the smaller the buffer can be. The flow control engine accomplishes the aforementioned by monitoring the quantity of data in the playback buffer and sending pause and resume commands to the server 38 contingent upon the playback buffer containing data in excess of or below predetermined thresholds, respectively. In short, it sends pause and resume commands to the server to activate or de-activate transmission of content to the device. The flow control engine pushes content data using the transfer engine directly into the end of the playback buffer when in the resume mode.

The User Interface Update Engine

The user interface update engine receives progress notifications from the rendering engine and utilizes the notifications for the purpose of updating interface progress displays. The User Interface Update Engine communicates to the user notifications of the transpiration of progress in rendering of content by evaluating through communication with the rendering engine the status of preparation of data for playback. The user interface update engine updates the screens on the device to display track times, progress, and other relevant information. In the preferred embodiment, it generates these displays directly from the information sent to it by the rendering engine.

The User Engine

The user engine provides a human interface that can translate human commands entered into the device into control commands issued to either the rendering engine or to the transfer engine, depending on which issued command is appropriate. The user engine communicates requested content to the transfer engine and runs play-related features. The user engine receives commands from the user and is responsible for communicating exclusively with the transfer engine and rendering engines. The user engine notifies the transfer engine of requested content or collections and of alterations requested by users, i.e. track change, position change within track, start and stop. The user engine notifies the rendering engine of playback alterations requiring modified behavior with reference to data contained in a playback buffer, i.e. pause and resume playback, and requests that the playback buffer be flushed.

With reference to FIGS. 4A-B, the basic logic of the software 100 is represented. A user first establishes activation, preferably through a website, and enters the main menu (102-104). If the user is new, then the user establishes a new account by submitting and confirming requested information (106-112) before returning to the main menu. Next a user can access their account, received authentication and enter the action menu (114-118). The action menu comprises the managing of playlist, executing collections or executing content (120, 134 and 138). In managing a playlist, the user can edit, add to or delete a playlist (122 to 130). When executing a collection, selection or content, the user makes a selection, executes it and issue desired control commands, preferably through the playing device 12. Prior to playing, the selection is decoded or decrypted and played utilizing the buffer and a client/server feedback and constant data algorithm.

A web-site will be the foundation of the network of the preferred embodiment of the instant invention. Everything is done through the site in this embodiment. However, the system and methods can be carried out using ordinary land based telecommunications as may occur to those skilled in the art. Users open accounts, buy terminals 12, and buy any content he or she wants through the content server system 20, which may, as referenced above, be done on a website associated with the system. The software also allows users to set up their play lists, which is how they choose their content to play through the terminals 12. In addition, the software allows users to provide or deny access to any of their individual terminals for security reasons. This is to deter theft of playing devices 12 so that when a terminal 12 is stolen, the user's entire collection will no longer be accessible to the thief. Each account can be set up to manage and control a plurality of different terminals with access to the collection or content. This is to prevent subscribers with full collections from selling access to an authorized party without the party setting up his or her own account.

In the embodiment, there are three main types of terminals 12. The first is the wireless and portable “Walkman” style terminal. This will be a relatively small, hand-held device that will preferably run on a rechargeable (e.g. Lithium Ion) battery as in cell phones and laptops. It allows subscribers to go anywhere they want and still have complete access to their entire collection. The second terminal will be a home stereo version. This will also use a wireless connection to access the collection as in the portable terminal, but will use regular AC as a power source. The third terminal will be a car stereo version. This will be the same as the home stereo terminal but will run on the car's power as a regular car stereo does.

In an Internet-based system, access to the system is commenced when someone sets up an account at the web-site and thus becomes a “subscriber”. Once this is done, he or she can begin to order terminals and desired content. According to the number of terminals the user has, he or she will be sent a computer chip or some other identifier for each one, or the terminals will be provided with an identifier. This chip will electronically identify the user and terminal. Once the user purchases a selection, he or she will have instant, continuous and permanent access to that selection. The selection is digitally compressed (e.g. MP3) and given a specific Internet or database memory location that only the users who have bought the selection (i.e. subscribers) have access to. The user then presses the “update Playlist” button on his or her Terminal, which uses a wireless connection to the Internet and downloads the updated selection(s) and corresponding access codes. This only needs to be done when a new selection is acquired. Otherwise, the Terminal stores the Playlist until it is updated again.

When the user selects the selection on his or her Terminal, the device uses a high-speed wireless Internet connection to go to the designated memory location of that selection. The Terminal knows the location because access to the information is given to the user's account when he or she buys the album, which is then relayed to the Terminal when the “Update Playlist” button is pressed. The user then will have two options. One is to stream the selection(s), which will allow almost instant access to the content. The second option is for the Terminal to download the full selection(s) to one of the numerous temporary memory spaces of the Terminal within seconds in digitally compressed format. This is called the QuickMemory option, which is similar to a multi-disk CD changer. A copy of the selection is internally stored on the Terminal so the user can listen to the selection without being connected to the Internet. This is useful when a user enters a dead spot in transmission/reception. Using the QuickMemory, the user can choose any selection stored in the terminal's memory. When the user wants to choose a new selection from their collection that is not in any of his or her QuickMemory spaces, they first select from the Playlist on the Terminal's screen. It is then downloaded to an empty memory space, or to one with an album already stored in it, replacing and overwriting the previous album that was there.

In the preferred embodiment, the system will run on Windows CE and will use 2.5G or 3G wireless broadband communication, and there may even be a fixed communication link between the terminal and the system, similar to today's DSL Internet connections in system which are land based or wired, the change over to a wireless system simply entails replacing the network interface card in the terminal with a wireless card such as a PCI card or PCMCIA card.

In the embodiment where the hand-held terminal 12 is the only terminal which the subscriber utilizes to connect to the system, and from there connects the terminal to remote devices such as a home stereo or car stereo, the connection may be wired or wireless between the terminal 12 and the home or car stereo.

If a subscriber desires to play his or her collection of entertainment content on someone else's stereo system, the portable terminal will have a link system to all other terminals (home stereo, and other portable terminals). The portable terminal is simply connected to the second terminal using the link, and all of the subscriber's paid-for content is then accessible through the new system. Once unplugged, the previously connected stereo system will no longer have access to the system while the portable terminal still will. The link system may be configured to only work with a finite number of active accounts, such as two, which forces consumers to get their own accounts even if they wish to play someone else's content.

Wi-Fi can be used as an alternative connection to playing device 12. For example, in most homes, it is difficult to get full wireless service in a basement. With Wi-Fi, a terminal 12 uses dual-band technology, similar to what cellular phones use between analog and digital frequencies. The terminal 12 will first tryto locate the main signal, and, if it cannot, it will then automatically attempt to use Wi-Fi if available.

Another embodiment comprises a Digital-Radio. With the digital network in place for the music-on-demand system, the terminal 12 as Digital-Radio is a simple addition that will allow users to listen to radio stations in digital quality. It will use the invention to broadcast its stations to every terminal 12. This will essentially redefine the world of transmission radio, as conceptually an unlimited number of stations are made publicly accessible to terminal 12 users. Another embodiment comprises the ability to allow listeners to listen to live concerts in digital quality from any terminal 12 very soon after (e.g. within 4 hours of) the concert.

1. A system for accessing remotely stored entertainment content, comprising:
a central server connected to memory containing a plurality of entertainment content stored therein;
at least one portable subscriber terminal;
a telecommunications link adapted to connect the at least one portable subscriber terminal to the central server with a purpose of permitting communication between the server and the terminal and permitting retrieval of content requested by the subscriber;
means for permitting the subscriber to input commands to the terminal to be communicated by the telecommunications link to the server;
means associated with the server for receiving the subscriber commands and retrieving entertainment content from the memory storage and transmitting content to the terminal; and
means for modulating a flow of data representative of the content selected by the subscriber from the memory to the terminal in response to available data space within at least one transient data storage buffer.

2. The system of claim 1, wherein the system further includes a data buffer transient data storage buffer associated with the subscriber terminal, and, means for causing the flow of data from the memory to the terminal be interrupted upon a predetermined high byte threshold being reached within the buffer, and further causing the flow of data from the memory to the terminal to be resumed when the byte threshold in the buffer reaches a predetermined low threshold.

3. The system of claim 2, wherein the means for permitting the subscriber to input commands to the terminal includes a human/machine interface between a subscriber and the central server to permit a user of the terminal to cause content to be retrieved from memory and sent to the terminal for playback by the terminal.

4. The system of claim 1, wherein content cannot be retrieved from memory and transmitted to the terminal unless it has been paid for in advance.

5. The system of claim 1, further including:
a means for causing data comprising content to be transferred from the central server to transient data storage buffer;
means for processing the data representative of the content by removing any extraneous data therein prior to playback by the terminal; and
means for monitoring the status of processing of data by the means for processing and indicating the status of the transfer of data from the central server to the terminal.

6. The system of claim 1, further including:
a means for causing data comprising content to be transferred from the central server to transient data storage buffer;
means for processing the data representative of the content by removing any extraneous data therein prior to playback by the terminal; and
means for monitoring the status of processing of data by the means for processing and indicating the status of the transfer of data from the central server to the terminal.

7. A method for electronically distributing entertainment content, comprising the steps of:
distributing at least one subscriber terminal to a consumer;
permitting the consumer to establish a subscription account to purchase entertainment content through the terminal, the step of permitting the subscriber to establish a subscriber account including receiving payment means from the subscriber;
permitting the subscriber to select from a menu of available entertainment content to be purchased;
permitting the subscriber to select and purchase desired entertainment content from the menu;
storing the selection(s) of the subscriber on a selection list on the central server dedicated to the subscriber;
permitting the subscriber to access and download to the terminal any purchased entertainment content on the subscriber's content list at any time; and
whereby the subscriber can purchase rights to and access purchased entertainment content at any time without physically possessing a tangible article upon which the entertainment content resides.

8. The method of claim 7, wherein the step permitting the subscriber to download entertainment content to the terminal includes permitting the subscriber to store the entertainment content in memory means associated with the subscriber terminal.

9. The method of claim 7, wherein the step of permitting the subscriber to download entertainment content comprises streaming the entertainment content to the subscriber terminal for playback in real time.

10. The method of claim 8, wherein the step of downloading the entertainment content to the subscriber terminal includes causing data representative of the entertainment content to be transferred from the central server to the playback buffer, processing said data for playback by the subscriber terminal; modulating the flow of data from the server to the player in response to available space within the playback buffer; monitoring the status of the processing of the data and indicating the status to the subscriber via the subscriber terminal; and receiving at least one human command from the subscriber through a human/machine interface associated with the subscriber terminal.

11. The method of claim 10, wherein the human/machine interface includes a graphical user interface connected to the subscriber terminal.

12. The method of claim 10, wherein the human/machine interface is akeypad attached to the subscriber terminal.

13. The method of claim 10, wherein the human/machine interface is a touch sensitive screen.

14. The method of claim 9, wherein the step of downloading the entertainment content to the subscriber terminal includes causing data representative of the entertainment content to be transferred from the central server to the playback buffer, processing said data for playback by the subscriber terminal; modulating the flow of data from the server to the player in response to available space within the playback buffer; monitoring the status of the processing of the data and indicating the status to the subscriber via the subscriber terminal; and receiving at least one human command from the subscriber through a human/machine interface associated with the subscriber terminal.

15. The method of claim 14, wherein the human/machine interface includes a graphical user interface connected to the subscriber terminal.

16. The method of claim 14, wherein the human/machine interface is a keypad attached to the subscriber terminal.

17. The method of claim 14, wherein the human/machine interface is a touch sensitive screen.

18. A system for accessing remotely stored entertainment content, comprising:
a central server connected to memory containing a plurality of entertainment content stored therein;
at least one portable subscriber terminal;
a telecommunications link adapted to connect the at least one portable subscriber terminal to the central server with a purpose of permitting communication between the server and the terminal and permitting retrieval of content requested by the subscriber;
means for permitting the subscriber to input commands to the terminal to be communicated by the telecommunications link to the server;
means associated with the server for receiving the subscriber commands and retrieving entertainment content from the memory storage and transmitting content to the terminal;
means for modulating a flow of data representative of the content selected by the subscriber from the memory to the terminal in response to available data space within at least one transient data storage buffer; and
wherein the means for permitting includes a human/machine interface selected from the group consisting of graphical user interfaces, touch sensitive screens, voice recognition means, biometric scanners, and tough sensitive displays.

19. The system of claim 18, wherein the system further includes a data buffer transient data storage buffer associated with the subscriber terminal, and, means for causing the flow of data from the memory to the terminal be interrupted upon a predetermined high byte threshold being reached within the buffer, and further causing the flow of data from the memory to the terminal to be resumed when the byte threshold in the buffer reaches a predetermined low threshold.

20. The system of claim 19, wherein the means for permitting the subscriber to input commands to the terminal includes a human/machine interface between a subscriber and the central server to permit a user of the terminal to cause content to be retrieved from memory and sent to the terminal for playback by the terminal.
